(19) United States
(12) Patent Application Publication
(10) Pub. No.: US 2010/0030418 A1
(43) Pub. Date: Feb. 4, 2010

(54) ONLINE HEALTH MONITORING VIA MULTIDIMENSIONAL TEMPORAL DATA MINING

(75) Inventor: Steven W. Holland, St Clair, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/183,829

(22) Filed: Jul. 31, 2008

(51) Int. Cl. G01M 17/00; G06F 19/00

(52) U.S. Cl. 701/29

(57) ABSTRACT

A system and method for predicting the occurrence of an event in a vehicle. The method includes monitoring a data stream including multi-dimensional tokens having information about one or more vehicle operating parameters. Further, the method includes the identification of a pattern of values of the one or more operating parameters in the data stream by mining the data stream using a temporal data miner, and predicting the occurrence of the event based on the correlation between the detected pattern and a pre-recorded pattern.

### BACKGROUND OF THE INVENTION

1. Field of the Invention

This invention relates generally to a diagnostic and prognostic system and method and, more particularly, to a system and method for on-board condition and health monitoring of a vehicle using a multi-dimensional temporal data mining technique.

2. Discussion of the Related Art

Diagnostic and Prognostic techniques for vehicle state of health monitoring can help forecast the occurrence of a problem in order to take preventive measures before significant damage is done. These techniques become more important for systems where the failure of the system can have critical implications, such as danger to human life. Further, system manufacturers can prevent their customers from being dissatisfied due to the failure of various systems by using diagnostic and prognostic techniques. Previously sold systems by a manufacturer, for example, vehicles produced by an automobile manufacturer, can be monitored through a network, and if any kind of performance degradation is observed, this can be conveyed to the customer before it results in critical damage to the system.

Efforts have been made in the past to develop diagnostic and prognostic techniques to detect and localize performance degradations in various operating systems. Diagnostic and prognostic techniques are of significant commercial and military interest today, but efforts for their development tend to be ad-hoc, lengthy and expensive. Further, the complexity of the system often restricts realistic physical modeling of the components or interaction between different components or subsystems.

One existing method based on the principles of diagnosis and prognosis uses temporal data mining. This method has been applied in the telecom industry and in manufacturing facilities. The method, however, only involves mining of data streams that are composed of tokens or logical variables that are uni-dimensional. Since each token represents a single value corresponding to an operating parameter of the system, physical modeling of the interaction between the components becomes difficult and the ability of the method to forecast a failure of a system component is compromised. Further, the application of such a diagnostic and prognostic technique is not known in vehicles.

As the number of vehicles and their speed increases, there exists a need for better and more efficient safety systems, which will help take failure-preventive measures as soon as any performance degradation in the vehicle is noticed. In addition, the system must be compatible with commercially available, general purpose microprocessors used on vehicles. Further, the system should be provided with enough data points to produce a reliable forecast.

### SUMMARY OF THE INVENTION

In accordance with the teachings of the present invention, a system and method for predicting the occurrence of an event in a vehicle are disclosed. The method includes monitoring a data stream including multi-dimensional tokens having information about one or more vehicle operating parameters. Further, the method includes the identification of a pattern of values of the one or more operating parameters in the data stream by mining the data stream using a temporal data miner, and predicting the occurrence of the event based on the correlation between the detected pattern and a pre-recorded pattern.

Additional features of the present invention will become apparent from the following description and appended claims, taken in conjunction with the accompanying drawings.

### BRIEF DESCRIPTION OF THE DRAWINGS

FIG. 1 is a block diagram illustrating a method for predicting the occurrence of an event in a vehicle; and

FIG. 2 is an illustration of an exemplary string of multi-dimensional tokens to be mined by a temporal data miner.

### DETAILED DESCRIPTION OF THE EMBODIMENTS

The following discussion of the embodiments of the invention directed to a system and method for on-board condition monitoring of a vehicle using multi-dimensional temporal data mining is merely exemplary in nature, and is in no way intended to limit the invention or its applications or uses.

The present invention proposes a system and method for exploiting multi-dimensional temporal data mining to detect and localize performance degradations in operating vehicles. Multi-dimensional temporal data mining refers to the capability to detect statistically significant patterns in a serial data stream. It is assumed that the data stream includes tokens or logical values, and could include variables with numeric values or textual values. For purposes of this discussion, it is assumed that any numerical or textual value will be simply represented by a small set of logical values, which characterize the range of the numerical values, for example, low, medium or high pressure, in a context sensitive manner instead of an absolute numeric value with defined units.

The multi-dimensional aspect refers to the fact that each token can have additional dimensions, or descriptors, recorded with it. For example, one form of added dimensions could be spatial or Cartesian coordinates in the 2-space or 3-space. The spatial coordinates could also refer to electrical connectivity, logical connectivity, or a host of other relevant dimensions of significant to the domain of the application instead of normal geometric relationships. This increases the representational power of the tokens themselves.

A known set of performance degradations could be represented by a set of statistically significant patterns detected by the temporal data miner, which were not present in a reference state of operation.

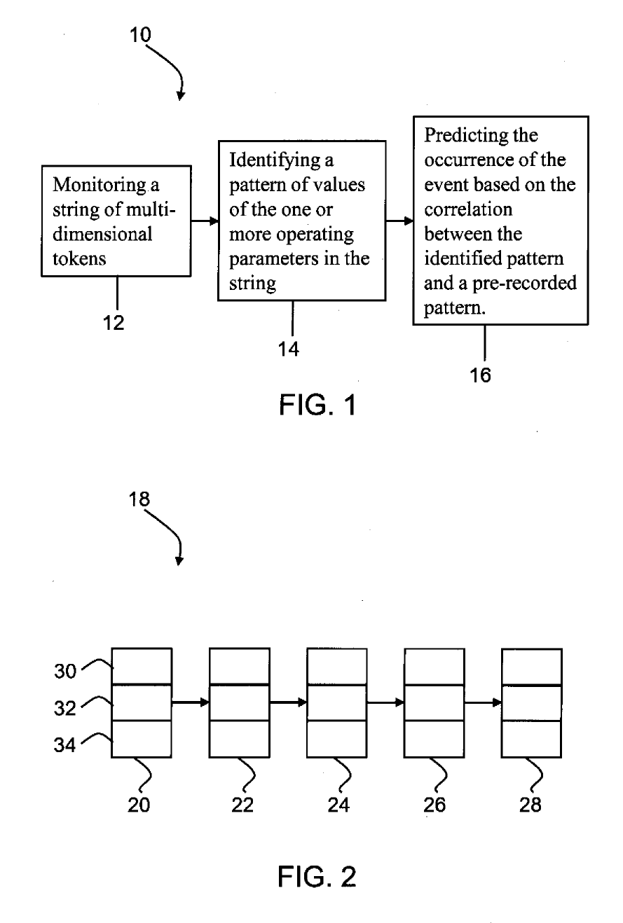

FIG. 1 is a block diagram 10 illustrating a process for predicting the occurrence of an event in a vehicle. The process begins at box 12 where a data stream or a string composed of multi-dimensional tokens or logical values is monitored. Each multi-dimensional token represents instantaneous values of various operating parameters of a vehicle at a given instance in time. For example, the multi-dimensional tokens can be diagnostic trouble codes (DTC) or events, which are detected on a communication bus of the vehicle. The tokens are said to be multi-dimensional since each token can have values of more than one operating parameter associated with it. The monitored string of multi-dimensional tokens is mined to identify hidden patterns of values at box 14. In an exemplary scenario, a temporal data miner can be used to monitor the string of multi-dimensional tokens and mine it to identify the patterns of values that are hidden. Temporal data mining refers to a technique for discovering hidden patterns in sequences or sub-sequences of events.

FIG. 2 is an illustration of an exemplary string of multi-dimensional tokens to be mined by a data miner. The string 18 is composed of time tagged multi-dimensional tokens 20, 22, 24, 26 and 28. The multi-dimensional aspect of the tokens is due to the additional information encoded by their various dimensions. For example, token 20 is shown to have dimensions 30, 32 and 34. In an exemplary scenario, the dimensions 30, 32 and 34 can include spatial relations between the values depicted by them. Dimension 30 is shown to capture physical connectivity while the dimensions 32 and 34 capture electrical and logical connectivity, respectively, between the values depicted by the tokens.

At box 16, the identified pattern of values is correlated or compared with a pre-recorded pattern of values of the same operating parameters. The patterns can be represented as graph structures for efficient processing. The occurrence of an event is forecasted based on the correlation between the two patterns. For example, a pre-recorded pattern can be made of three tokens occurring in the order A followed by B followed by C. If the identified pattern is composed of tokens A followed by B, the occurrence of event C can be predicted with some degree of certainty. Other patterns could be provided, such as A→(B and C and D)→E, where B, C and D must be detected after the occurrence of A and before the occurrence of E, but the order of occurrence of B, C and D is not important. Further, the time delay between the detection of one token before the occurrence of next token is user selectable. In an exemplary scenario, the identified pattern and the pre-recorded pattern are represented as graphs and are correlated using a fast graph matcher.

As mentioned above, in an automotive context, the tokens could represent a series of events detected on the vehicle communication bus, such as diagnostic trouble codes, which record that a certain condition is present in the vehicle. The DTCs will be time stamped and captured in the order of occurrence. The string of DTCs would be augmented by other state variables, environmental conditions, performance levels, etc. as determined to be relevant by a subject matter expert. This provides a technique for the subject matter expert to introduce important information into the data mining process in a system that does not require creation of complex models of the systems being monitored. Thus, the process seeks to efficiently utilize the subject matter expert's knowledge in an efficient matter.

If the forecasted event is indicative of an impending failure of a component, the vehicle driver is warned about the event. In one embodiment, the warning signal is conveyed to the driver through the communication bus of the vehicle. In another embodiment, the performance of the vehicle can be monitored through a centralized network, for example, the OnStar™ network. If any degradation in the performance of a component of the vehicle is observed, the network communicates it and its implications to the driver. However, it will be readily apparent to any person with ordinary skill in the art that the driver of the vehicle can be warned by methods other than those discussed in the embodiments given above.

The pre-recorded patterns are composed of values of operating parameters obtained when the performance of the vehicle is degraded. These patterns are recorded during a training phase, while the correlation between the identified pattern and the pre-recorded pattern is established during a real time execution phase, that is, on-board a running vehicle. The training phase and the execution phase are explained below.

During the training phase, a representative string of tokens for every known normal mode of operation is captured. The data recorded during each mode is assumed to be relatively stationary, that is, the patterns of operation would be present throughout the recording. These data-sets are then mined to detect all multi-dimensional temporal data patterns present in the normal mode of operation. Each of the mined patterns is represented as a graph structure and stored for future use and the patterns together represent the normal mode.

In the next part of the training, data streams corresponding to a degraded modes of operation of the system are captured. The performance of the system can be considered degraded based on the specifications by a subject matter expert. The data-sets corresponding to each level of performance degradation are captured in a manner similar to the one used for the normal mode. The degradations chosen by a subject matter expert are chosen in such a way that they represent performance reductions of some important and critical type, such as a reduction in the braking ability from the vehicle operational point of view. Each level of performance degradation is accomplished by tapping the subject matter expert's knowledge to determine the components that fail or degrade during actual usage. The end result is a set of data streams that characterizes known levels of performance degradation with a known cause.

The next step of training involves removal of the normal mode patterns (or graphs) from the patterns corresponding to the degraded mode of operation of the system to capture the new patterns or those which detect the trained degradation. Similarly, patterns that occur in multiple types of failure or degradation, and which, therefore, cannot be used to discriminate between problems, may also be removed.

For best performance, the subject matter expert filters the final set of patterns manually to eliminate those believed to be inappropriate. For example, a physical interpretation of the logical sequence might suggest something that is already understood and is not deemed relevant by the subject matter expert. Filtering could be manual or algorithmic (semi-automatic) in nature, and based on general rules from the subject matter expert.

During the real time execution phase, the fast graph matcher can be used to look for the occurrence of patterns associated with some form of failure or degradation, as identified during the training phase. As each node of the pattern is detected, the fast graph matcher continues to monitor the next node until the delay exceeds the allowable limit. Multiple instantiations of the same pattern could be in the process of detection at the same time to ensure that one instantiation did not time out while an identical pattern starting later in time is still being tracked. The run-time detection of patterns corresponding to the degraded mode of operation of the system is taken as a warning that the given degradation may be present in the running vehicle. The driver of the vehicle is warned about it, so that an impending failure or a severe loss of performance is prevented.

Various embodiments of the present invention offer one or more advantages. The present invention provides a method and system for predicting the occurrence of an event in a system, for example, a vehicle. The present invention serves to monitor the condition of the vehicle while it is in operation, and facilitates taking failure preventive measures as soon as some kind of performance degradation is observed. Further, the invention uses multi-dimensional temporal data mining to forecast the occurrence of an event, which makes the forecast reliable and easy.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for predicting an occurrence of an event in a vehicle, the method comprising:
monitoring a string of multi-dimensional tokens, wherein each multi-dimensional token of the string includes values of one or more operating parameters of the vehicle at an instant in time;
identifying a pattern of values of the one or more operating parameters in the string, wherein the pattern is identified by mining the string of multi-dimensional tokens; and
forecasting the occurrence of the event based on a correlation between the identified pattern and a pre-recorded pattern.

2. The method according to claim 1 wherein the multi-dimensional tokens are diagnostic trouble codes (DTCs) of the vehicle.

3. The method according to claim 1 wherein mining the string of multi-dimensional tokens is done using multi-dimensional temporal data mining technique.

4. The method according to claim 1 wherein a time interval between the instants of time corresponding to adjacent multi-dimensional tokens is user selectable.

5. The method according to claim 1 wherein the pre-recorded pattern corresponds to a degraded mode of operation of the vehicle and is obtained by filtering out strings of multi-dimensional tokens corresponding to a normal mode of operation from a degraded mode of operation of the vehicle.

6. The method according to claim 1 further comprising warning a driver of the vehicle when the forecasted event is a failure.

7. A method for detecting performance degradations in operating vehicles, said method comprising:
monitoring a serial data stream on the vehicle where the serial data stream includes logical values and each logical value identifies more than one operating parameter of the vehicle;
detecting patterns of the logical values in the serial data stream;
comparing the detected patterns of logical values to known patterns of logical values; and
determining the occurrence of a degradation event based on the comparison between the detected patterns and the known patterns.

8. The method according to claim 7 wherein the logical values include diagnostics trouble codes of the vehicle.

9. The method according to claim 7 further comprising determining the known patterns of logical values by identifying strings of logical values for normal modes of operations of the vehicle.

10. The method according to claim 9 wherein determining the known patterns includes identifying known patterns of the logical values for degraded modes of operation of the vehicle.

11. The method according to claim 10 wherein determining the known patterns includes removing the normal mode patterns corresponding to degraded mode patterns so that the known patterns that are compared to the detected patterns are for degraded modes of operation.

12. The method according to claim 11 wherein determining the known patterns includes removing patterns that occur in multiple types of failures or degradations.

13. The method according to claim 9 wherein determining the known patterns includes identifying the know patterns by a person having expertise in identifying modes of operation of the vehicle.

14. The method according to claim 7 wherein the detected patterns of logical values and the known patterns of logical values are represented as graphs, and wherein comparing the detected patterns to the known patterns include using a graph matcher.

15. A system for predicting an occurrence of an event in a vehicle, the system comprising:
a data miner for identifying a pattern by mining a string of multi-dimensional tokens, wherein each multi-dimensional token of the string includes values of one or more operating parameters of the vehicle at an instant of time corresponding to the multi-dimensional token; and
a graph matcher to correlate the identified pattern and a pre-recorded pattern, wherein the occurrence of the event is forecasted based on the correlation between the identified pattern and the pre-recorded pattern.

16. The system according to claim 15 wherein the multi-dimensional tokens are diagnostic trouble codes (DTCs) of the vehicle.

17. The system according to claim 15 wherein the data mining engine is a temporal data miner.

18. The system according to claim 15 wherein a time interval between the instants corresponding to the multi-dimensional token is user selectable.

19. The system according to claim 15 further comprising a warning signal generator for warning the driver of the vehicle when the event is a failure.
